(19) United States
(12) Patent Application Publication
(10) Pub. No.: US 2010/0059158 A1
(43) Pub. Date: Mar. 11, 2010

(54) TIRE FOR VEHICLE WHEELS COMPRISING AN IMPROVED ELASTOMERIC COMPONENT

(75) Inventors: Francesca Baione, Milano (IT); Fabrizia Sala, Milano (IT); Stefano Tresoldi, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Pirelli TYre S.p.A

(21) Appl. No.: 12/312,185

(22) PCT Filed: Oct. 30, 2006
(86) PCT No.: PCT/EP2006/010412

§ 371 Date: Apr. 29, 2009

(51) Int. Cl. B60C 9/00; B60C 1/00; D03D 13/00; C08J 5/14

(52) U.S. Cl. 152/451; 152/537; 428/222; 523/157

(57) ABSTRACT

A tire for vehicle wheel includes at least one elastomeric component including a crosslinked elastomeric material obtained by crosslinking an elastomeric composition including at least one diene elastomeric polymer; at least one sulfur-based vulcanizing agent, and at least one adhesion promoting agent having formula HOOC—R—S—R′—COOH wherein each of R and R′, equal or different from each other, is a divalent organic group. In a preferred embodiment of the first aspect of the present invention, the elastomeric component includes a metal reinforcing agent embedded therein.

### FIELD OF THE INVENTION

The present invention relates to a tire for vehicle wheels comprising an improved elastomeric component, wherein the elastomeric component preferably comprises a metal reinforcing element covered with an elastomeric composition comprising a tiodicarboxylic acid as an adhesion promoter.

### BACKGROUND OF THE ART

It is well known in the art to reinforce rubber articles or products with metal elements such as steel cords. It is, of course, of the utmost importance to have a strong bond between the rubber and the metal element which should be maintained over a long period of time, even under severe aging or using conditions. One of the most important phenomena which causes a reduction of rubber-metal bonding is the oxidation of the metal surface, especially in the case of steel cords. These corrosion problems have generally been reduced by coating the steel wire with brass or other alloys.

Further improvement in the adhesion of rubber to coated wire, particularly brass plated steel wire, has been proposed.

For example, U.S. Pat. No. 4,075,159 to Koyama et al. discloses the addition of benzoic acid or monohydroxybenzoic acid to rubber to improve the adhesion of rubber to brass plated reinforcing elements.

U.S. Pat. No. 4,182,639 to Pignocco et al. discloses a method for improving the adhesion of brass-coated steel cord to rubber by coating the cord with specific combination of sulfur-containing rubber vulcanization accelerating agents and organic or inorganic phosphate corrosion inhibitors.

U.S. Pat. No. 4,513,123 discloses a sulfur-curable rubber skim stock which upon curing exhibits improved adhesion to brass-plated steel under high humidity, heat aging conditions. The sulfur-curable rubber skim stock comprises natural rubber or a blend of natural rubber and synthetic rubber, carbon black, an organo-cobalt compound, sulfur and a small amount of dithiodipropionic acid.

U.S. Pat. No. 4,532,080 to Delseth et al. discloses a method to increase the bond strength between a sulphur-vulcanizable rubber and a metal, especially brass, by using in the sulphur-vulcanizable rubber, as bonding promoter, an organic substance containing one or more groups of the formula —S—SO₂R where R represents (a) a radical —OM where M is a monovalent metal, the equivalent of a multivalent metal, a monovalent ion derived by the addition of a proton to a nitrogenous base or the equivalent of a multivalent ion derived by the addition of two or more protons to a nitrogenous base, or (b) an organic radical.

U.S. Pat. No. 4,851,469 to Saitoh discloses the use of a combination of silica, a resorcin donor, a methylene donor and an organic sulfur-containing compound to improve the adhesion of sulfur-vulcanizable rubber to brass.

U.S. Pat. No. 5,085,905 to Beck discloses an elastomeric composition having improved adhesion to metal reinforcement, the elastomeric composition comprising an elastomer containing an adhesion promoting amount of a polysulfide.

U.S. Pat. No. 5,394,919 to Sandstrom et al. discloses a laminate of rubber and steel cord, which may be brass coated steel, where the rubber comprises an elastomer, carbon black, optionally silica, dithiodipropionic acid and methylene donor material. The combination of dithiodipropionic acid, carbon black, optionally silica, and the methylene donor is described to enhance the rubber adhesion to cord.

The Applicant has faced the technical problem of improving adhesion of crosslinked elastomeric materials to metals, particularly to metal reinforcing elements embedded in the elastomeric material.

Moreover, the Applicant has also faced the problem of improving adhesion between tyre components including crosslinked elastomeric materials. A small adhesion may occur when the tyre components include different elastomeric materials, but may also occur when the elastomeric materials are the same, such as in case of multilayer carcass structures or belt structures. The poor adhesion of different components comprising the same crosslinked elastomeric material can cause, for example, detachment of belt edges or carcass ply edges, in particular under heavy load and stressed conditions.

The Applicant has now found that the addition of a tiodicarboxylic acid to a crosslinkable elastomeric composition improves the adhesion of the resulting crosslinked elastomeric material to a metal reinforcing element embedded therein.

The Applicant has also found that the addition of said tiodicarboxylic acid allows to obtain crosslinked elastomeric materials which show improved adhesion to adjacent components present in the tire, the abovementioned detachments problems being so avoided.

Said improvements are obtained without having a negative impact on the remaining properties of said elastomeric compositions, in particular, mechanical properties (both static and dynamic), hysteresis, and hardness.

According to a first aspect, the present invention relates to a tire for vehicle wheels, comprising at least one elastomeric component comprising a crosslinked elastomeric material obtained by crosslinking an elastomeric composition comprising:
at least one diene elastomeric polymer;
at least one sulfur-based vulcanizing agent, and
at least one adhesion promoting agent having formula

HOOC—R—S—R′—COOH

wherein each of R and R′, equal or different from each other, is a divalent organic group.

In a preferred embodiment of the first aspect of the present invention, said elastomeric component comprises a metal reinforcing agent embedded therein.

According to a second aspect, the present invention relates to an elastomeric article comprising a crosslinkable elastomeric composition, said crosslinkable elastomeric composition comprising:
at least one diene elastomeric polymer;
at least one sulfur-based vulcanizing agent, and
at least one adhesion promoting agent having formula

HOOC—R—S—R′—COOH

wherein each of R and R′, equal or different from each other, is a divalent organic group.

In a preferred embodiment of the second aspect of the present invention, said elastomeric article comprises a metal reinforcing agent embedded therein.

According to a further aspect, the present invention relates to a crosslinkable elastomeric composition comprising:
at least one diene elastomeric polymer;
at least one sulfur-based vulcanizing agent, and
at least one compound having formula

HOOC—R—S—R′—COOH

wherein each of R and R′, equal or different from each other, is a divalent organic group.

When the term “group” is used in this invention to describe a chemical compound or substituent, the described chemical material includes the basic group and that group with conventional substitution. For example, “alkyl group” includes not only the unsubstituted alkyl as methyl, ethyl, octyl, tearyl, etc., but also the alkyl bearing substituents groups such as halogen, cyano, hydroxy, nitro, amino, carboxylate, and the like.

According to one preferred embodiment, each of R and R′ is a divalent organic group having an aliphatic structure or an aromatic structure.

Preferably, aliphatic groups represented by R and R′ may comprise from 1 to 12 carbon atoms and may include a linear, branched, or cyclic structure. Further preferably, aromatic groups represented by R and R′ may comprise from 6 to 14 carbon atoms.

Divalent organic groups having a linear or branched alkylene structure include, for example, methylene, ethylene, propane-1,1-diyl, propane-1,2-diyl, propane-1,3-diyl, butane-1,1-diyl, butane-1,2-diyl, butane-1,3-diyl, butane-1,4-diyl, pentane-1,1-diyl, pentane-1,2-diyl, pentane-1,3-diyl, pentane-1,4-diyl, pentane-1,5-diyl, hexane-1,1-diyl, hexane-1,2-diyl, hexane-1,3-diyl, hexane-1,4-diyl, hexane-1,5-diyl, hexane-1,6-diyl, octane-1,8-diyl, dodecane-1,12-diyl, and the like.

Divalent organic groups having a cyclic alkylene structure include, for example, cyclopropane-1,1-diyl, cyclopropane-1,2-diyl, cyclobutane-1,1-diyl, cyclobutane-1,2-diyl, cyclobutane-1,3-diyl, cyclopentane-1,1-diyl, cyclopentane-1,2-diyl, cyclopentane-1,3-diyl, cyclohexane-1,1-diyl, cyclohexane-1,2-diyl, cyclohexane-1,3-diyl, cyclohexane-1,4-diyl, and the like.

Divalent organic groups having an aromatic structure include, for example, phenylene, naphthylene, biphenylene, and polyphenylene.

These divalent organic groups may include a group having an element other than a carbon atom and a hydrogen atom, such as, for example, oxygen, nitrogen, sulfur and the like. Examples of such groups include hydroxide group (—OH), ether group (—O—), mercapto group (—SH), thio group (—S—), sulfinyl group (—SO—), sulfonyl group (—SO₂—), sulfo group (—SO₃H), carboxy group (—COOH), carbonyl group (—CO—), oxycarbonyl group (—O—CO—), nitro group (—NO₂), amino group (—NH₂), imino group (—NH—), imido group, (═NH), amido group (—CONH₂), halogen atoms (Br—, Cl—, I—, F—), and the like.

According to a more preferred embodiment, R and R′ are selected from the group comprising methylene, propylene, cyclohexylene, and phenylene.

Useful adhesion promoting agents include the following exemplified, but not limitative compounds:

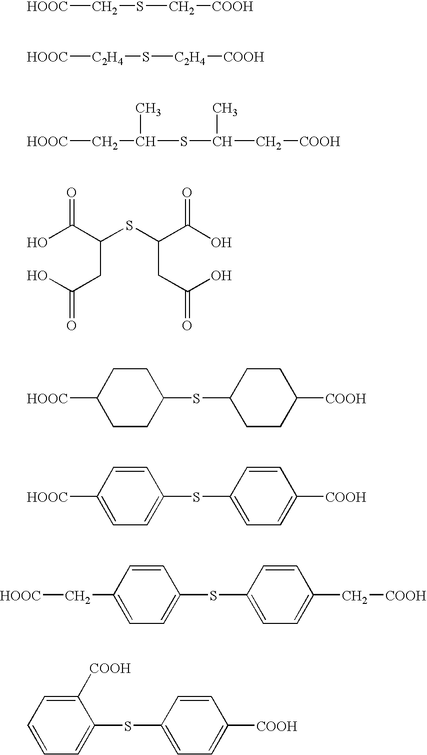

The adhesion promoters defined above are very effective in promoting bonding between the crosslinked elastomeric material and other tyre components comprising similar or different crosslinked elastomeric material as well as between the crosslinked elastomeric material and metal reinforcing elements embedded therein.

Said adhesion promoter is present in the crosslinkable elastomeric composition of the present invention in an amount generally of from 0.1 phr to 10 phr, preferably from 0.2 phr to 5 phr.

The metal reinforcing elements used in the practice of this invention can have a wide variety of structural configurations, but will generally be a metal elongated element such as, for example, a cord, a strand, or a wire. For example, a wire cord used in the practice of this invention can be composed of 1 to 50 or even more filaments of metal wire which are twisted together to form a metal cord. Therefore, such a cord can be monofilament in nature, or can be composed of multiple filaments, or multiple strands or a combination of filaments and strands. For example, the cords used in automobile tires generally are composed of three to six twisted filaments, the cords used in truck tires normally contain 10 to 30 twisted filaments, and the cords used in giant earth mover tires generally contain 40 to 50 twisted filaments.

The metal generally used in the reinforcing elements of this invention is steel. The term “steel” as used in the present specification and claims refers to what is commonly known as carbon steel, which is also called high-carbon steel, ordinary steel, straight carbon steel, and plain carbon steel. An example of such a steel is American Iron and Steel Institute Grade 1070-high-carbon steel (AISI 1070). Such steel owes its properties chiefly to the presence of carbon without substantial amounts of other alloying elements. It is generally preferred for steel reinforcements to be individually coated or plated with transition or post-transition metals or alloy thereof. Some representative examples of suitable metals include: zirconium, cerium, lanthanum, manganese, molybdenum, nickel, cobalt, tin, titanium, zinc, and copper. Some representative examples of suitable alloys thereof include brass and bronze. Brass is an alloy of copper and zinc which can contain other metals in varying lesser amounts and bronze is an alloy of copper and tin which sometimes contains traces of other metals. The metal reinforcements which are generally most preferred for use in the practice of this invention are brass plated carbon steels. The brass typically has a copper content of from 60 to 70% by weight, more especially from 63 to 68% by weight, with the optimum percentage depending on the particular conditions under which the bond is formed. The brass coating on brass-coated steel can have a thickness of, for example, from 0.05 to 1 micrometer, preferably from 0.07 to 0.7 micrometer, for example from 0.15 to 0.4 micrometer.

According to one preferred embodiment, the diene elastomeric polymer which may be used in the present invention may be selected from those commonly used in sulfur-crosslinkable elastomeric compositions, that are particularly suitable for producing tires, that is to say from elastomeric polymers or copolymers with an unsaturated chain having a glass transition temperature (Tg) generally below 20° C., preferably in the range of from 0° C. to −110° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2 phenyl-1,3-butadiene, or mixtures thereof.

Monovnylarenes which may optionally be used as co-monomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer or copolymer may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The crosslinkable elastomeric composition according to the present invention may optionally comprises at least one elastomeric polymer of one or more monoolefins with an olefinic comonomer or derivatives thereof, which have been already disclosed above. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer or copolymer or an elastomeric polymer selected from those above disclosed which has been functionalized by reaction with at least one suitable terminating agent or coupling agent may also be used. In particular, the diene elastomeric polymers or copolymers obtained by anionic polymerization in the presence of an organometallic initiator (in particular an organolithium initiator) may be functionalized by reacting the residual organometallic groups derived from the initiator with at least one suitable terminating agent or coupling agent selected, for example, from: imines, carbodiimides, alkyltin halides, substituted benzophenones, alkoxysilanes or aryloxysilanes (see, for example, European Patent EP 451,604, or Patents U.S. Pat. No. 4,742,124 and U.S. Pat. No. 4,550,142).

For the purposes of the present description and of the claims, the term “phr” means the parts by weight of a given component of the crosslinkable elastomeric composition per 100 parts by weight of the diene elastomeric polymer.

According to one preferred embodiment, the sulfur-based vulcanizing agent may be selected from sulfur or derivatives thereof such as, for example:
soluble sulfur (crystalline sulfur);
insoluble sulfur (polymeric sulfur);
sulfur dispersed in oil (for example a dispersion of 33% sulfur in oil known under the trade name Crystex® OT33 from Flexsys);
sulfur donors such as, for example, tetramethylthiuram disulfide (TMTD), tetrabenzylthiuram disulfide (TBzTD), tetraethylthiuram disulfide (TETD); tetrabutylthiuram disulfide (TBTD), dimethyldiphenyl-thiuram disulfide (MPTD), pentamethylenethiuram tetra-sulfide or hexasulfide (DPTT), morpholinobenzothiazole disulfide (MBSS), N-oxydiethylenedithiocarbamyl-N′-oxydiethylene-sulphenamide (OTOS), dithiodimorpholine (DTM or DTDM), caprolactam disulfide (CLD).

Said sulfur-based vulcanizing agent is present in the crosslinkable elastomeric composition of the present invention in an amount generally of from 0.5 phr to 5 phr, preferably from 1 phr to 3 phr.

At least one reinforcing filler may be advantageously added to the crosslinkable elastomeric composition of the present invention, in an amount generally of from 0.1 phr to 120 phr, preferably from 20 phr to 90 phr. The reinforcing filler may be selected from those commonly used for crosslinked manufactured products, in particular for tires, such as, for example, carbon black, silica, alumina, aluminosilicates, calcium carbonate, kaolin, or mixtures thereof.

The types of carbon black which may be used in the present invention may be selected from those conventionally used in the production of tires, generally having a surface area of not less than 20 m²/g (determined by CTAB absorption as described in Standard ISO 6810:1995).

The silica which may be used in the present invention may be, generally, a pyrogenic silica or, preferably, a precipitated silica, with a BET surface area (measured according to Standard ISO standard 5794-1:1994) of from 50 m²/g to 500 m²/g, preferably from 70 m²/g to 200 m²/g.

The crosslinkable elastomeric composition of the present invention may be vulcanized according to known techniques. To this end, in the composition, after a first stage of thermal-mechanical processing, a sulfur-based vulcanizing agent is incorporated together with vulcanization accelerators and activators. In this second processing stage, the temperature is generally kept below 120° C. and preferably below 100° C., so as to avoid any unwanted pre-crosslinking phenomena.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid, and also BiO, PbO, Pb₃O₄, PbO₂, or mixtures thereof. Accelerators that are commonly used may be selected from: dithiocarbamates, guanidine, thiourea, thiazoles, sulfenamides, thiurams, amines, xanthates, or mixtures thereof.

The crosslinkable elastomeric composition according to the present invention may comprise other commonly used additives selected on the basis of the specific application for which the composition is intended. For example, the following may be added to said composition: antioxidants, anti-aging agents, plasticizers, adhesives, anti-ozone agents, modifying resins, fibers (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to the crosslinkable elastomeric composition according to the present invention. The amount of plasticizer generally ranges from 2 phr to 100 phr, preferably from 5 phr to 50 phr.

The crosslinkable elastomeric composition according to the present invention may be prepared by mixing together the elastomeric polymeric materials, the sulfur-based vulcanizing agent, and the adhesion promoting agent with the other additives according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss) or of co-rotating or counter-rotating twin-screw type.

### BRIEF DESCRIPTION OF THE DRAWING

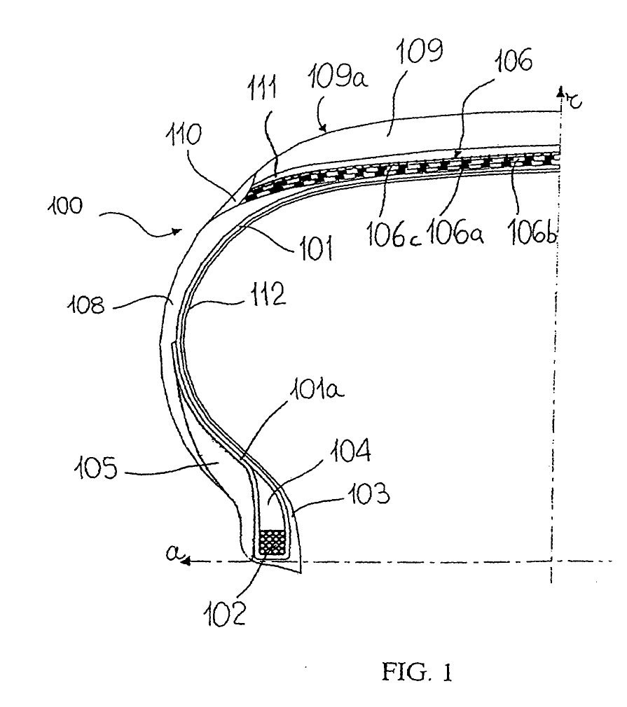

The present invention will now be illustrated in further detail by means of an illustrative embodiment, with reference to the attached FIG. 1, which is a view in cross section of a portion of a tire made according to the invention.

“a” indicates an axial direction and “r” indicates a radial direction. For simplicity, FIG. 1 shows only a portion of the tire, the remaining portion not represented being identical and symmetrically arranged with respect to the radial direction “r”.

### DETAILED DESCRIPTION OF THE PREFERRED EMBODIMENTS

The tire (100) comprises at least one carcass ply (101) shaped in a substantially toroidal configuration, the opposite lateral edges of which are associated with respective Bead wires (102). The association between the carcass ply (101) and the bead wires (102) is achieved here by folding back the opposite lateral edges of the carcass ply (101) around the bead wires (102) so as to form the so-called carcass back-folds (101a) as shown in FIG. 1.

Alternatively, the bead wires (102) can be replaced with a pair of annular inserts formed from elongate components comprising a metal reinforcing element and a crosslinkable elastomeric composition according to the present invention arranged in concentric coils (not represented in FIG. 1) (see, for example, European Patent Applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing elements arranged parallel to each other and at least partially coated with a layer of elastomeric compound according to the present invention. These reinforcing elements are often made of steel wires stranded together, coated with a metal alloy (for example copper/zinc, zinc/manganese, zinc/molybdenum/cobalt alloys, and the like).

The carcass ply (101) is usually of radial type, i.e. it incorporates elastomeric articles according to the present invention arranged in a substantially perpendicular direction relative to a circumferential direction. Each bead wire (102) is enclosed in a bead (103), defined along an inner circumferential edge of the tire (100), with which the tire engages on a rim (not represented in FIG. 1) forming part of a vehicle wheel. The space defined by each carcass back-fold (101a) contains a bead filler (104) wherein the bead wires (102) are embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of elastomeric articles according to the present invention, typically comprising a metal cord and a crosslinkable elastomeric component, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101), this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tires, a rubber layer (112) generally known as a “liner”, which provides the necessary impermeability to the inflation air of the tire, may also be provided in a radially internal position relative to the carcass ply (101).

The process for producing the tire according to the present invention may be carried out according to techniques and using apparatus that are known in the art, as described, for example, in European Patent EP 199,064 and in Patents U.S. Pat. No. 4,872,822, U.S. Pat. No. 4,768,937, said process including at least one stage of manufacturing the green tire and at least one stage of vulcanizing this tire. Alternative processes for producing a tire or parts of a tire without using semi-finished products are disclosed, for example, in the above mentioned Patent Applications EP 928,680 and EP 928,702.

Although the present invention has been illustrated specifically in relation to a tire, other crosslinked elastomeric manufactured products that may be produced according to the invention may be, for example, belts such as, conveyor belts, power belts or driving belts; flooring and footpaths which may be used for recreational area, for industrial area, for sport or safety surfaces; flooring tiles; mats such as, antistatic computer mats, automotive floor mats; mounting pads; shock absorbers sheetings; sound barriers; membrane protections; shoe soles; carpet underlay; automotive bumpers; wheel arch liner; seals such as, automotive door or window seals; o-rings; gaskets; watering systems; pipes or hoses materials; flower pots; building blocks; roofing materials; geomembranes; and the like.

The present invention will be further illustrated below by means of a number of preparation examples, which are given for purely indicative purposes and without any limitation of this invention.

### EXAMPLE 1

### Adhesion of the Vulcanized Elastomeric Material

The adhesion of the vulcanized elastomeric material to steel cords was measured on test pieces of vulcanized mixture on a brass coated steel cord made of 3 wires having a diameter of 0.28 mm), using the method described in “Kautschk and Gummi Kunststoffe”, 5, 228-232, (1969), which measures the force required to remove a cord from a cylinder of vulcanized rubber.

The “pull-out force” was measured in Newtons using an electronic dynamometer. The values were measured both on freshly prepared vulcanized test pieces and on test pieces after age-hardening for sixteen days at a temperature of 65° C. and at 90% relative humidity (R.H.). The measure was repeated on ten different test pieces and the results were averaged.

The composition of the mixture which formed the vulcanized rubber was, in parts % by weight, as described in the following Table 1:

TABLE 1

| | Sample | | | | |
|---|---|---|---|---|---|
| | 1 | 2 | 3 | 4 | 5 |
| | (Ref.) | (Inv.) | (Inv.) | (Comp.) | (Inv.) |
| Natural rubber | 100.00 | 100.00 | 100.00 | 100.00 | 100.00 |
| Carbon black | 60.00 | 60.00 | 60.00 | 60.00 | 60.00 |
| ZnO | 10.00 | 10.00 | 10.00 | 10.00 | 10.00 |
| Cobalt salt | 1.00 | 1.00 | 1.00 | 1.00 | 1.00 |
| 6-PPD | 1.00 | 1.00 | 1.00 | 1.00 | 1.00 |
| DCBS | 1.50 | 1.50 | 1.50 | 1.50 | 1.50 |
| PVI | 0.20 | 0.20 | 0.20 | 0.20 | 0.20 |
| Sulphur | 5.00 | 5.00 | 5.00 | 5.00 | 5.00 |
| Thiodipropionic acid | — | 0.50 | 2.50 | — | — |
| Dithiodipropionic acid | — | — | — | 0.50 | — |
| Tiodibenzoic acid | — | — | — | — | 0.50 |

Ref.: Reference
Comp.: Comparison (as suggested in U.S. Pat. No. 5,394,919)
Inv.: Invention
6-PPD (antioxidant): N-(1,3-dimethylbutyl)-N′-phenyl-p-phenylenediamine;
PVI (retardant): N-cyclohexylthiophthalimide (San-togard ® PVI - Flexys);
DCBS (accelerator): benzothiazyl-2-dicyclohexyl-sulfenamide (Vulkacit ® DZ/EGC - Lanxess).

The results are shown in Tables 2 for fresh samples and on Table 3 for aged samples.

TABLE 2

| | Average | |
|---|---|---|
| Fresh | Pull-out | |
| Sample | Force | Coverage |
| 1 | 264 | 100% |
| 2 | 288 | 100% |
| 3 | 288 | 100% |
| 4 | 276 | 100% |
| 5 | 283 | 100% |

TABLE 3

| | Average | |
|---|---|---|
| Aged | Pull-out | |
| Sample | Force | Coverage |
| 1 | 204 | 90% |
| 2 | 233 | 100% |
| 3 | 246 | 100% |
| 4 | 241 | 90% |
| 5 | 243 | 95% |

### EXAMPLE 2

The static mechanical properties according to Standard ISO 37:1994 as well as hardness in IRHD degrees at 23° C. according to ISO standard 48:1994, were measured on samples of the above mentioned elastomeric compositions vulcanized at 170° C. for 10 min. The results are given in Table 4.

The crosslinkable elastomeric compositions were also subjected to MDR rheometric analysis using a Monsanto MDR rheometer, the tests being carried out at 170° C. for 20 minutes at an oscillation frequency of 1.66 Hz (100 oscillations per minute) and an oscillation amplitude of ±0.5°°, measuring the minimum and maximum torque (ML and MH) and the time required to reach 30%, 60%, and 90% of the final torque value (T30, T60, and T90). The results are given in Table 4.

Table 4 also shows the dynamic mechanical properties, measured using an Instron dynamic device in the traction-compression mode according to the following methods. A test piece of the crosslinked elastomeric composition obtained as disclosed above (vulcanized at 170° C. for 10 min) having a cylindrical form (length=25 mm; diameter=14 mm), compression-preloaded up to a 25% longitudinal deformation with respect to the initial length, and kept at the prefixed temperature (23° C. or 70° C.) for the whole duration of the test, was submitted to a dynamic sinusoidal strain having an amplitude of ±3.5% with respect to the length under preload, with a 100 Hz frequency. The dynamic mechanical properties are expressed in terms of dynamic elastic modulus (E′) and Tan delta (loss factor) values. The Tan delta value is calculated as a ratio between viscous modulus (E″) and elastic modulus (E′).

Furthermore, the crosslinkable elastomeric compositions obtained as disclosed above were subjected to adhesion (peeling) tests.

Using the elastomeric compositions obtained as described above, two-layer test pieces were prepared for measuring the peel force, by superimposing two layers of the same non-crosslinked elastomeric composition, followed by crosslinking (at 170° C., for 10 minutes). In detail, the test pieces were prepared as follows. Each elastomeric composition was calendered so as to obtain a sheet with a thickness equal to 3 mm±0.2 mm. From the sheet thus produced were obtained plates with dimensions equal to 220 mm (±1.0 mm)×220 mm (±1.0 mm)×3 mm (±0.2 mm), marking the direction of the calendering. One side of each plate was protected with a polyethylene sheet, while a reinforcing fabric made of rubberized polyamide with a thickness of 0.88 mm±0.05 mm was applied to the opposite side, orienting the strands in the direction of calendering and rolling the composite thus assembled so as to achieve good adhesion between the fabric and the non-crosslinked elastomeric composition. After cooling, sheets were produced from the composite thus obtained, by punching, these sheets having dimensions equal to 110 mm (±1.0 mm)×25 mm (±1.0 mm)×3.88 mm (±0.05 mm), taking care to ensure that the major axis of each sheet was oriented in the direction of the strands of the fabric.

A first sheet made of the crosslinkable elastomeric composition obtained as disclosed above constituting the first layer was placed in a mould, the polyethylene film was removed, two Mylar® strips acting as lateral separators (thickness=0.2 mm) were applied laterally and a third strip again made of Mylar® (thickness=0.045 mm) was applied to one extremity of the sheet in order to create a short free section not adhering to the second layer. A second sheet made of the same crosslinkable elastomeric composition above disclosed, from which the polyethylene film was previously removed, was then applied to the first sheet thus prepared, constituting the second layer (the first layer and the second layer being made of the same crosslinkable elastomeric composition), thus obtaining a test piece which was then crosslinked by heating at 170° C., for 10 min, in a press.

Subsequently, the test pieces crosslinked as described above were conditioned at room temperature (23° C.±2° C.) for at least 16 hours and were then subjected to the peel test using a Zwick 2005 dynamometer, the clamps of which were applied to the free section of each layer. A traction speed equal to 260 mm/min±20 mm/min was then applied and the peel force values thus measured, expressed in Newtons (N), are given in Table 4 and are each the average value calculated for 4 test pieces. The same tests were carried out on the test pieces crosslinked as described above and conditioned at 100° C. for at least 16 hours: the obtained results were given on Table 4 and are each the average value calculated for 4 test pieces.

TABLE 4

| SAMPLE | 1 (Ref.) | 2 (Inv.) | 4 (Comp.) | 5 (Inv.) |
|---|---|---|---|---|
| 100% Modulus | 5.041 | 5.167 | 5.383 | 4.973 |
| (CA1) (MPa) | | | | |
| Stress at break | 16.130 | 15.306 | 16.306 | 15.713 |
| (MPa) | | | | |
| Elongation at | 271.75 | 276.94 | 285.57 | 294.14 |
| break (%) | | | | |
| ML (dN m) | 2.760 | 2.270 | 2.120 | 2.140 |
| MH (dN m) | 33.430 | 33.080 | 33.680 | 31.070 |
| T30 (min) | 1.390 | 1.460 | 1.430 | 1.140 |
| T60 (min) | 1.910 | 2.010 | 2.030 | 1.570 |
| T90 (min) | 3.220 | 3.360 | 3.500 | 2.700 |
| E′ (23° C.) | 10.899 | 10.795 | 10.994 | 10.211 |
| E′ (70° C.) | 9.031 | 8.939 | 9.118 | 8.456 |
| Tan delta (23° C.) | 0.179 | 0.203 | 0.199 | 0.196 |
| Tan delta (70° C.) | 0.105 | 0.118 | 0.117 | 0.112 |
| Peeling (23° C.) | 210.0 | 198.0 | 156.1 | 218.1 |
| Peeling (100° C.) | 124.7 | 132.7 | 101.5 | 141.3 |

1-57. (canceled)

58. A tire for a vehicle wheel, comprising at least one elastomeric component comprising a crosslinked elastomeric material obtained by crosslinking an elastomeric composition comprising:
at least one diene elastomeric polymer;
at least one sulfur-based vulcanizing agent, and
at least one adhesion promoting agent having formula
HOOC—R—S—R′—COOH
wherein each of R and R′, equal or different from each other, is a divalent organic group.

59. The tire for a vehicle wheel according to claim 58, wherein each of R and R′, equal or different from each other, is a divalent aliphatic group comprising 1 to 12 carbon atoms.

60. The tire for a vehicle wheel according to claim 58, wherein each of R and R′, equal or different from each other, is a divalent aliphatic group having a linear, branched, or cyclic structure.

61. The tire for a vehicle wheel according to claim 60, wherein each of R and R′, equal or different from each other, is a linear or branched aliphatic group selected from the group comprising methylene, ethylene, propane-1,1-diyl, propane-1, 2-diyl, propane-1,3-diyl, butane-1,1-diyl, butane-1,2-diyl, butane-1,3-diyl, butane-1,4-diyl, pentane-1,1-diyl, pentane-1,2-diyl, pentane-1,3-diyl, pentane-1,4-diyl, pentane-1,5-diyl, hexane-1,1-diyl, hexane-1,2-diyl, hexane-1,3-diyl, hexane-1,4-diyl, hexane-1,5-diyl, hexane-1,6-diyl, octane-1,8-diyl, and dodecane-1,12-diyl.

62. The tire for a vehicle wheel according to claim 60, wherein each of R and R′, equal or different from each other, is a cyclic aliphatic group selected from the group comprising cyclopropane-1,1-diyl, cyclopropane-1,2-diyl, cyclobutane-1,1-diyl, cyclobutane-1,2-diyl, cyclobutane-1,3-diyl, cyclopentane-1,1-diyl, cyclopen-tane-1,2-diyl, cyclopentane-1,3-diyl, cyclohexane-1,1-diyl, cyclohexane-1,2-diyl, cyclohexane-1,3-diyl, and cyclohexane-1,4-diyl.

63. The tire for a vehicle wheel according to claim 58, wherein each of R and R′, equal or different from each other, is a divalent aromatic group comprising 6 to 14 carbon atoms.

64. The tire for a vehicle wheel according to claim 58, wherein each of R and R′, equal or different from each other, is an aromatic group selected from the group comprising phenylene, naphthylene, biphenylene, and polyphenylene.

65. The tire for a vehicle wheel according to claim 58, wherein each of R and R′, equal or different from each other, comprise a group having an element other than a carbon atom and a hydrogen atom.

66. The tire for a vehicle wheel according to claim 65, wherein said group having an element other than a carbon atom and a hydrogen atom is selected from hydroxide group (—OH), ether group (—O—), mercapto group (—SH), thio group (—S—), sulfinyl group (—SO—), sulfonyl group (—SO₂—), sulfo group (—SO₃H), carboxy group (—COOH), carbonyl group (—CO—), oxycarbonyl group (—O—CO—), nitro group (—NO₂), amino group (—NH₂), imino group (—NH—), imido group, (═NH), amido group (—CONH₂), and halogen atoms (Br—, Cl—, I—, F—).

67. The tire for a vehicle wheel according to claim 58, wherein said elastomeric component comprises a metal reinforcing agent embedded therein.

68. The tire for a vehicle wheel according to claim 67, wherein said metal reinforcing element is an elongated element.

69. The tire for a vehicle wheel according to claim 67, wherein said metal reinforcing element is a metal cord comprising 1 to 50 metal wire filaments.

70. The tire for a vehicle wheel according to claim 69, wherein said metal wire filaments are twisted or cabled together to form said metal cord.

71. The tire for a vehicle wheel according to claim 67, wherein said metal is steel.

72. The tire for a vehicle wheel according to claim 67, wherein said metal is coated or plated with a transition or post-transition metal or alloy thereof.

73. The tire for a vehicle wheel according to claim 72, wherein said transition or post-transition metal is selected from the group comprising zirconium, cerium, lanthanum, manganese, molybdenum, nickel, cobalt, tin, titanium, zinc, and copper.

74. The tire for a vehicle wheel according to claim 72, wherein said alloy is selected from the group comprising brass and bronze.

75. The tire for a vehicle wheel according to claim 58, comprising:
a carcass structure shaped in a substantially toroidal configuration comprising opposite lateral edges and a plurality of reinforcing cords, the opposite lateral edges of which are associated with respective right-hand and left-hand bead wires to form respective beads;
a belt structure applied in a radially external position with respect to said carcass structure comprising a plurality of reinforcing cords;
a tread band radially superimposed on said belt structure; and a pair of sidewalls applied laterally on opposite sides with respect to said carcass structure,
wherein said reinforcing cords comprise at least one of said elastomeric components.

76. The tire for a vehicle wheel according to claim 75, wherein each of R and R′, equal or different from each other, is a divalent aliphatic group comprising 1 to 12 carbon atoms.

77. The tire for a vehicle wheel according to claim 75, wherein said plurality of reinforcing cords is at least partially embedded in said crosslinked elastomeric material.

78. The tire for a vehicle wheel according to claim 75, wherein said carcass structure comprises said plurality of reinforcing cords arranged parallel to each other.

79. The tire for a vehicle wheel according to claim 75, wherein said carcass structure comprises said plurality of reinforcing cords arranged in a substantially perpendicular direction relative to a circumferential direction.

80. The tire for a vehicle wheel according to claim 75, wherein said belt structure comprises two belt strips incorporating said plurality of reinforcing cords.

81. The tire for a vehicle wheel according to claim 80, wherein said two belt strips intersect each other and are oriented so as to form a predetermined angle relative to a circumferential direction.

82. An elastomeric article comprising a crosslinkable elastomeric composition, said crosslinkable elastomeric composition comprising:
at least one diene elastomeric polymer;
at least one sulfur-based vulcanizing agent; and
at least one adhesion promoting agent having the formula
HOOC—R—S—R′—COOH
wherein each of R and R′, equal or different from each other, is a divalent organic group.

83. The elastomeric article according to claim 82, wherein each of R and R′, equal or different from each other, is a divalent aliphatic group comprising 1 to 12 carbon atoms.

84. The elastomeric article according to claim 82, wherein each of R and R′, equal or different from each other, is a divalent aliphatic group having a linear, branched, or cyclic structure.

85. The elastomeric article according to claim 82, wherein each of R and R′, equal or different from each other, is a linear or branched aliphatic group selected from the group comprising methylene, ethylene, propane-1,1-diyl, propane-1,2-diyl, propane-1,3-diyl, butane-1,1-diyl, butane-1,2-diyl, butane-1,3-diyl, butane-1,4-diyl, pentane-1,1-diyl, pentane-1,2-diyl, pentane-1,3-diyl, pentane-1,4-diyl, pentane-1,5-diyl, hexane-1,1-diyl, hexane-1,2-diyl, hexane-1,3-diyl, hexane-1,4-diyl, hexane-1,5-diyl, hexane-1,6-diyl, octane-1,8-diyl, and dodecane-1,12-diyl.

86. The elastomeric article according to claim 82, wherein each of R and R′, equal or different from each other, is a cyclic aliphatic group selected from the group comprising cyclopropane-1,1-diyl, cyclopropane-1,2-diyl, cyclobutane-1,1-diyl, cyclobutane-1,2-diyl, cyclobutane-1,3-diyl, cyclopentane-1,1-diyl, cyclopentane-1,2-diyl, cyclopentane-1,3-diyl, cyclohexane-1,1-diyl, cyclohexane-1,2-diyl, cyclohexane-1,3-diyl, and cyclohexane-1,4-diyl.

87. The elastomeric article according to claim 82, wherein each of R and R′, equal or different from each other, is a divalent aromatic group comprising 6 to 14 carbon atoms.

88. The elastomeric article according to claim 82, wherein each of R and R′, equal or different from each other, is an aromatic group selected from the group comprising phenylene, naphthylene, biphenylene, and polyphenylene.

89. The elastomeric article according to claim 82, wherein each of R and R′, equal or different from each other, comprises a group having an element other than a carbon atom and a hydrogen atom.

90. The elastomeric article according to claim 89, wherein said group having an element other than a carbon atom and a hydrogen atom is selected from hydroxide group (—OH), ether group (—O—), mercapto group (—SH), thio group (—S—), sulfinyl group (—SO—), sulfonyl group (—SO₂—), sulfo group (—SO₃H), carboxy group (—COOH), carbonyl group (—CO—), oxycarbonyl group (—O—CO—), nitro group (—NO₂), amino group (—NH₂), imino group (—NH—), imido group, (═NH), amido group (—CONH₂), and halogen atoms (Br—, Cl—, I—, F—).

91. The elastomeric article according to claim 82, wherein said elastomeric composition comprises a metal reinforcing agent embedded therein.

92. The elastomeric article according to claim 91, wherein said metal reinforcing element is an elongated element.

93. The elastomeric article according to claim 91, wherein said metal reinforcing element is a metal cord comprising 1 to 50 metal wire filaments.

94. The elastomeric article according to claim 93, wherein said metal wire filaments are twisted or cabled together to form said metal cord.

95. The elastomeric article according to claim 92, wherein said metal is steel.

96. The elastomeric article according to claim 92, wherein said metal is coated or plated with a transition or post-transition metal or alloy thereof.

97. The elastomeric article according to claim 96, wherein said transition or post-transition metal is selected from the group comprising zirconium, cerium, lanthanum, manganese, molybdenum, nickel, cobalt, tin, titanium, zinc, and copper.

98. The elastomeric article according to claim 96, wherein said alloy is selected from the group comprising brass and bronze.
